(19) United States
(12) Patent Application Publication
(10) Pub. No.: US 2018/0160362 A1
(43) Pub. Date: Jun. 7, 2018

(54) Methods for Performing Cell Global Identity (CGI) Measurements on Wireless Communication Devices

(71) Applicant: QUALCOMM Incorporated, San Diego, CA (US)

(72) Inventors: Shravan Kumar Raghunathan, San Diego, CA (US); Muthukumaran Dhanapal, San Diego, CA (US); Parthasarathy Krishnamoorthy, San Diego, CA (US); Vijay Marwah, San Diego, CA (US)

(21) Appl. No.: 15/371,928

(22) Filed: Dec. 7, 2016

(51) Int. Cl. H04W 48/16; H04W 24/10; H04W 76/04

(52) U.S. Cl. CPC H04W 48/16; H04W 84/042; H04W 76/048; H04W 24/10

(57) ABSTRACT

Various embodiments include methods performed on a wireless communication device for facilitating cell global identity (CGI) measurements when a call is underway using a first wireless communication technology (e.g., LTE) and the CGI measurement is to be conducted on a cell supporting a second wireless communication technology. A processor of the wireless communication device may perform power scans of a plurality of neighboring cells supporting the second communication technology, and select one of the plurality of neighboring cells based on the power scans. The processor may conduct a CGI measurement of the selected neighboring cell, and report measurement results to the wireless network. The processor of the wireless communication device may store a history of CGI measurement and/or camping on cells of the second communication technology, and use the stored information when power scans of neighboring cells yield similar results.

### BACKGROUND

Some designs of wireless communication devices—such as smart phones, tablet computers, and laptop computers—include radio frequency (RF) resources that are configured to access mobile telephony networks using two or more different radio access technologies (RATs). Examples of radio access technologies (RATs) used by mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1×RTT), and Universal Mobile Telecommunications Systems (UMTS). For example, a wireless communication device may be configured to communicate with a wireless network using LTE or GSM, with the ability to switch (i.e., perform a “handover”) between the two RATs as directed by the wireless network if conditions favor communications using one RAT or the other.

Wireless communication devices typically include circuitry for receiving one or more Subscriber Identity Modules (SIM) on which are stored user subscription information that enables the device to communicate with a particular wireless network. A wireless communication device that includes one or more SIMs and connects to two or more separate mobile telephony networks using a shared radio frequency (RF) resource/radio may be termed a multi-SIM multi-standby (MSMS) communication device. An example of an MSMS communication device is a dual-SIM dual standby (DSDS) communication device, which includes two SIM cards supporting two subscriptions associated with different RATs sharing one RF resource. In DSDS communication devices, the separate subscriptions share the one RF resource to communicate with two separate mobile telephony networks on behalf of their respective subscriptions. When one subscription is using the RF resource, the other subscription is in stand-by mode and is not able to communicate using the RF resource.

Another type of multi-SIM wireless communication device is a multi-SIM multi-active (MSMA) device that is configured with multiple RF resources that support multiple SIMs allowing two or more subscriptions to be monitored simultaneously even when a call is underway on one subscription. An example of an MSMA device is a dual-SIM dual-active (DSDA) device with two RF resources and two SIMs/subscriptions. Each SIM, or subscription, may utilize one of the RF resources for communication and thus multiple subscriptions may be actively communicating at the same time.

### SUMMARY

Various embodiments include methods implemented on a wireless communication device for facilitating cell global identity (CGI) measurements of a cellular base station (“cell”) of the wireless network when a call is being conducted using a first communication technology (e.g., LTE) to a cell of the wireless network and the cell to be measured is using a second communication technology (e.g., GSM). Various embodiments may include performing a power scan for each of a plurality of neighboring cells supporting the second communication technology, selecting a neighboring cell from the plurality of neighboring cells based on the power scan of each of the plurality of neighboring cells, conducting a CGI measurement of the selected neighboring cell, and reporting the CGI measurement of the selected neighboring cell to the wireless network. In some embodiments, performing the power scan for each of the plurality of neighboring cells supporting the second communication technology may include performing the power scan for each of the plurality of neighboring cells supporting the second communication technology during a discontinuous reception period. In some embodiments, selecting a neighboring cell from the plurality of neighboring cells may include selecting a neighboring cell with a highest signal strength based on the power scan of each of the plurality of neighboring cells. In some embodiments, selecting a neighboring cell from the plurality of neighboring cells may be further based on information of prior camping history of the wireless communication device on cells supporting the second communication technology. Some embodiments may further include determining whether the CGI measurement of the selected cell was successfully completed, and in response to determining that the CGI measurement of the selected cell was not successfully completed; selecting another neighboring cell from the plurality of neighboring cells based on the power scan of each of the plurality of neighboring cells, conducting a CGI measurement of the selected other neighboring cell, and reporting the CGI measurement of the selected other neighboring cell to the wireless network.

Some embodiments may further include obtaining a list of the plurality of neighboring cells from the wireless, in which the list may include a radio resource control reconfiguration message including a frequency of each of the plurality of neighboring cells.

Further embodiments include a wireless communication device having an RF resource and a processor configured with processor-executable instructions to perform operations of the methods summarized above. Further embodiments include a wireless communication device having means for performing functions of the methods summarized above. Further embodiments include non-transitory processor-readable media on which are stored processor-executable instructions configured to cause a processor of the wireless communication device to perform operations of the methods summarized above.

### BRIEF DESCRIPTION OF THE DRAWINGS

The accompanying drawings, which are incorporated herein and constitute part of this specification, illustrate embodiments, and together with the general description and the detailed description given herein, serve to explain the features of the disclosed systems and methods.

FIG. 1 is a communication system block diagram of wireless telephony networks suitable for use with various embodiments.

FIG. 2 is a component block diagram of a multi-SIM wireless communication device suitable for use with various embodiments.

FIG. 3 is a system architecture diagram illustrating example protocol layer stacks implemented by a wireless communication device suitable for use with various embodiments.

FIG. 4 is a call flow diagram illustrating handovers on a wireless communication device according to conventional methods.

FIG. 5 is a call flow diagram illustrating handovers on a wireless communication device according to various embodiments.

FIGS. 6A and 6B are process flow diagrams illustrating methods for facilitating CGI measurements of cells supporting a second communication technology on a wireless communication device according to various embodiments.

FIG. 7 is a component block diagram of a wireless communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular embodiments and implementations are for illustrative purposes, and are not intended to limit the scope of the written description or the claims.

Various embodiments include improved methods for a wireless communication device communicating with a wireless network using a first communication technology (e.g., LTE) to perform CGI measurements of cells supporting a second communication technology (e.g., GSM) during an active call on the wireless communication device. Various embodiments may come into play when the wireless communication device is supporting a call via the wireless network using a first communication technology (e.g., LTE) in the discontinuous reception (DRX) mode and the network signals (e.g., sending a measConfig message) the device a to obtain and report CGI measurements of a cell supporting the second communication technology (e.g., GSM). In this situation, the wireless communication device may conduct a power scan of all neighboring cells supporting the second communication technology and select one of the neighboring cells based on the power scan (e.g., the cell with the strongest signal and/or most reliable handover history). The wireless communication device may then conduct the CGI measurement of the selected cell, and report the results to the wireless network.

Conducting the CGI measurement on a cell selected from among a plurality of cells based upon the observed power levels improves the chances of successfully obtaining an acceptable CGI measurement on the first attempt. This may improve the overall performance of wireless communication devices, because the chances of a delay in reporting the CGI measurement is reduced. Upon receiving a measConfig message, a wireless communication device will continue to attempt to obtain the CGI measurement (which includes decoding a master information block (MIB) and a system information block (SIB) of the target cell) until a complete CGI information is recovered, the request is cancelled by the network or a timer (T321) expires, which is typically about eight seconds). This delay in using the RF resources for communications may impact the user experience. Also, failure to obtain the CGI information may lead to a RAT handover (e.g., LTE to GSM) failure and/or Single Radio Voice Call Continuity (SRVCC), so the various embodiments reduce the chances such failures will occur.

Further performance improvements may be offered by various embodiments in MSMS wireless communication devices in which multiple subscriptions share a single RF resource, because only one subscription can communicate at a time using the UEs radio resources. In MSMS devices, when a first subscription is performing CGI measurements, the other subscription(s) sharing the RF resource are generally not allowed to acquire the RF resource. Thus, if the first subscription takes an excessive amount of time to perform CGI measurements, a second (and third) subscription is unable to communicate with an associated wireless network to perform the routine network operations (e.g., acquisition, paging, voice call etc.). This may delay receiving pages, which could delay acquisition and paging on the second subscription and thus impact the user experience.

As used herein, the term “wireless communication device,” “multi-SIM wireless communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two wireless communication networks with one or more shared RF resources. Various embodiments may be useful in wireless communication devices, such as smart phones, and so such devices are referred to in the descriptions of various embodiments. However, the embodiments may be useful in any electronic devices that may individually maintain one or more subscriptions that utilize one or more RF resources able to communicate with a wireless network using two or more different communication technologies (i.e., RATs).

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless communication device on a network and enable a communication service with the network. Because the information stored in a SIM enables the wireless communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

Mobile telephony networks control a number of serving cells that provide network service in various geographic areas. A macrocell, such as a high power cellular base station, is type of cell that provides network coverage over a relatively large area. Smaller cells, such as microcells, picocells, and femtocells, are lower power base stations that cover smaller geographic areas. Wireless communication devices may conduct measurement control/reports for detecting the signal strength of a target cell. For example, the wireless communication device may tune an RF resource to the target cell and measure the signal strength. The signal strength measurement may be conducted relatively quickly because the wireless communication device does not have to decode a system information block (SIB) or master information block (MIB) of the target cell to obtain the measurement.

Occasionally, the wireless communication device may perform a cell global identity (CGI) measurement of a cell to acquire the CGI of the cell. Each cell worldwide may have a unique CGI, and so the CGI measurement may uniquely identify the cell at a global level. A CGI measurement may include receiving and decoding the SIB/MIB of the target cell to acquire the CGI, public land mobile network (PLMN), location area code (LAC), and other information about the target cell. The CGI measurements take a longer amount of time to complete than signal strength measurements.

When a wireless communication device supports an ongoing call with a wireless network (e.g., a voice or data call) in DRX mode, communications associated with the call may pause periodically for a period of time (i.e., the “DRX period”). A wireless communication device may conduct CGI measurements during a DRX period. During the DRX period, the RF resource may be used to perform a CGI measurement on a neighboring cell that uses another communication technology or RAT. For example, if the wireless communication device is conducting the call with the wireless network using the LTE communication technology, the network may send a measConfig message specifying that the CGI of a cell supporting the GSM communication technology. In that event, the wireless communication device may utilize its dedicated RF resource to perform the CGI measurement.

Conventionally wireless communication devices are configured to perform a single CGI measurement during the DRX period when prompted to report a CGI measurement by the network in a radio resource control (RRC) reconfiguration message. The RRC reconfiguration message may include a list of the frequencies of neighboring cells of the network using the second communication technology (e.g., GSM). Conventionally, the wireless communication device chooses the first neighboring cell in the measurement configuration message to perform the CGI measurement (e.g., the nearest neighboring cell). However, the nearest neighboring cell may not be the best cell obtaining a CGI measurement or for conducting a handover. For example, there may be other neighboring cells with stronger signal strengths or are generally more reliable. If the wireless communication device is not able to measure the CGI immediately, the resulting delay may adversely impact the performance of the subscription. For example, the first subscription may experience a single radio voice call continuity (SRVCC) failure if a handover of a voice call from a cell using a first communication technology (e.g., LTE) to a cell using a second communication technology (e.g., GSM) is unsuccessful. In addition, a second subscription may experience a delay in receiving pages if a shared RF resource is dominated by the first subscription attempting unsuccessfully to obtain a CGI measurement from a cell with which the wireless communication device is unable to communicate.

Various embodiments provide devices and methods implemented with a processor of a wireless communication device for obtaining CGI measurements to increase the likelihood that a CGI measurement is successfully obtained. Various embodiments may be implemented in a variety of types of wireless communication devices, including but not limited to MSMS devices and MSMA devices, configured to communicate with one or more wireless networks using a first communication technology (e.g., LTE) and a second communication technology (e.g., GSM). Various embodiments may be implemented when a first subscription is supporting a call in DRX mode using the first communication technology (e.g., LTE) and the network signals the device to measure and report the CGI value of a cell using a second communication technology (e.g., GSM).

In response, the wireless communication device may perform power scans of all the neighboring cells that use the second communication technology during the DRX period of the active call (data or voice) on the first subscription. A processor of the wireless communication device may select a neighboring cell based on the power scans. For example, the processor may select the neighboring cell with the highest signal strength. If multiple neighboring cells have similar signal strengths, the processor may utilize information about prior CGI measurements or communication technology handovers to select one of the neighboring cells. For example, the processor may store in memory a database of prior CGI measurements or communication technology handovers including information regarding whether those measurements or handovers were successful. The processor may select one of the neighboring cell to obtain the CGI measurement based on the information in the database. For example, the processor may select the neighboring cell that is the most reliable based on the information in the database.

The wireless communication device may perform a CGI measurement for the selected neighboring cell to acquire the CGI of the selected neighboring cell and other information. This process may be performed during a DRX cycle of the ongoing data or voice call on the first subscription and include decoding the SIB/MIB obtained from the CGI measurement to obtain the CGI, PLMN, LAC, and other information of the selected cell. The wireless communication device may then report the information to the network. By conducting a power scan of all neighboring cells and selecting the neighboring cell based on the measurements (e.g., selecting the cell that has the strongest signal and/or is most reliable), the wireless communication device may increase the likelihood that the CGI measurement will be completed successfully and that services on the first and second subscriptions are not negatively impacted.

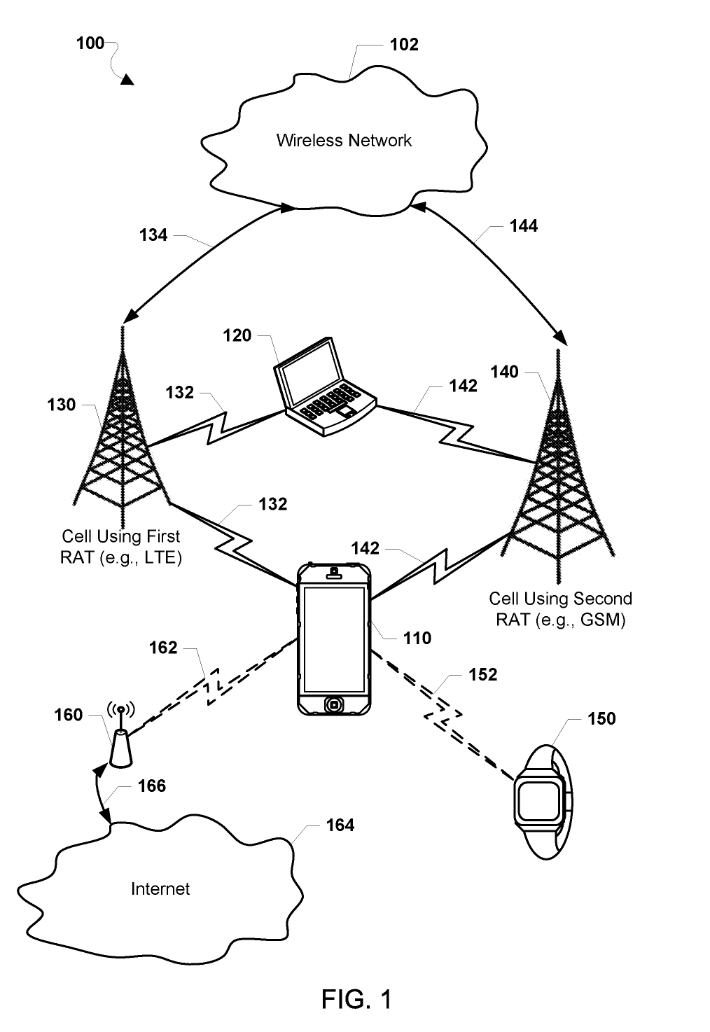

Various embodiments may be implemented within a variety of communication systems 100, an example of which is illustrated in FIG. 1. A wireless network 102 typically each includes a plurality of cellular base stations or “cells) (e.g., a first cell 130 and a second cell 140). Some wireless networks support communications with wireless communication devices 110 using two or more communication technologies, such as LTE and GSM. A wireless communication device 110 may be in communication with the wireless network 102 through a first cell 130 using a first communication technology 132 (e.g., LTE). The wireless communication device 110 may also or alternatively be in communication with the wireless network 102 using a communication technology 142 (e.g., GSM) to another cell 140. The two cells 130, 140 may be in communication with the first mobile network 102 over wired connections 134, 144.

In some situations, the wireless network 102 may instruct a wireless communication device 110 communicating with the network using the first communication technology 132 to obtain and report CGI information from cells using the second communication technology 142. The communication technologies 132 and 142 may be two or more of Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UNITS), and other mobile telephony communication technologies or RATs.

In some embodiments, the wireless communication device 110 may optionally establish a wireless connection 152 with a peripheral device 150 used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may optionally establish a wireless connection 162 with a wireless access point 160, such as over a Wi-Fi connection. The wireless access point 160 may be configured to connect to the Internet 164 or another network over a wired connection 166.

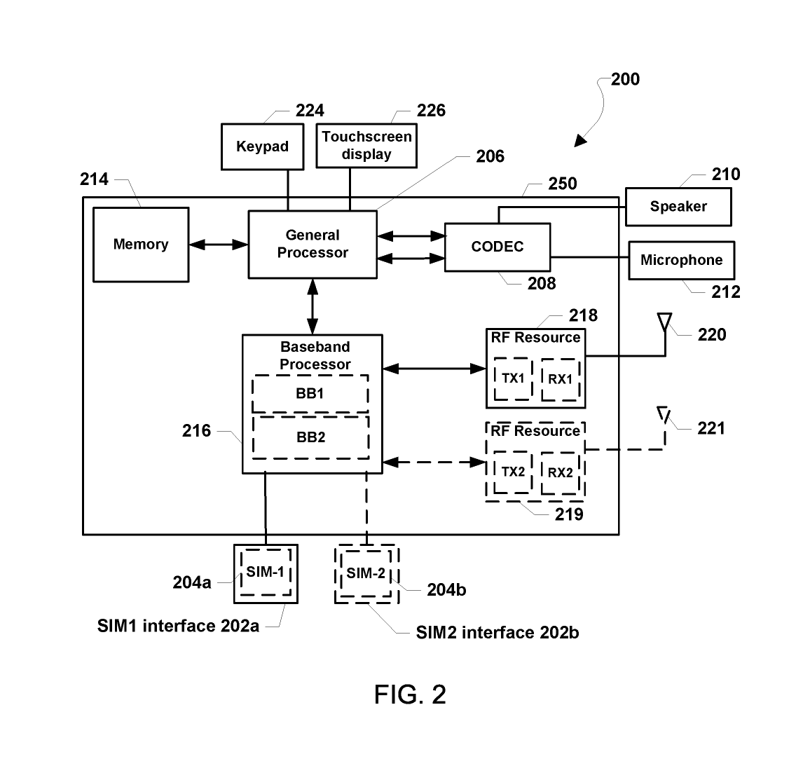

FIG. 2 is a functional block diagram of a multi-SIM wireless communication device 200 suitable for implementing various embodiments. With reference to FIGS. 1-2, the multi-SIM wireless communication device 200 may be similar to the wireless communication device 110 as described. The multi-SIM wireless communication device 200 may include a first SIM interface 202a, which may receive a first identity module SIM-1 204a that is associated with a first subscription. Optionally, the multi-SIM wireless communication device 200 may also include a second SIM interface 202b, which may receive an optional second identity module SIM-2 204b that is associated with a second subscription.

A SIM in various embodiments may be a Universal Integrated Circuit Card (UICC) that is configured with SIM applications, enabling access to, for example, GSM and/or UNITS networks. The UICC may also provide storage for a phone book and other applications. In a CDMA network, a SIM may be a UICC removable user identity module (R-UIM) or a CDMA subscriber identity module (CSIM) on a card. In some implementations, the SIM may include information to enable communicating via a wireless network using two different communication technologies or RATs, such as LTE and GSM. A SIM card may have a central processing unit (CPU), read only memory (ROM), random access memory (RAM), electrically erasable programmable read only memory (EEPROM) and input/out (I/O) circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM wireless communication device 200 (e.g., in a memory 214), and thus need not be a separate or removable circuit, chip or card.

The multi-SIM wireless communication device 200 may include at least one programmable controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. The memory 214 may store an operating system (OS), as well as user application software and executable instructions.

The general processor 206 and the memory 214 may each be coupled to at least one baseband modem processor 216 coupled to one or more RF resources 218, 219 coupled to an antenna 220. 221. A baseband processor 216-RF resource 218 chain may include the baseband modem processor 216, which may perform baseband/modem functions for communications with/controlling the RF resource and coordinating communications with wireless networks. The baseband processor 216 and RF resource(s) 218 (219) may be configured to communicate with wireless networks (e.g., 102) using two or more different communication technologies or RATs, such as LTE and GSM. In some embodiments, each baseband-RF resource chain may include physically or logically separate baseband processors (e.g., BB1, BB2).

The RF resource 218 may be a transceiver that performs transmit/receive functions for different communication technologies or RATs. The RF resource 218 may include separate transmit and receive circuitry, or may include a transceiver that combines transmitter and receiver functions. In some embodiments, the RF resource 218 may include multiple receive circuitries. The RF resource 218 may be coupled to a wireless antenna (e.g., a wireless antenna 220). In some optional embodiments, the multi-SIM wireless communication device 200 may include an optional RF resource 219 configured similarly to the RF resource 218 and coupled to an optional wireless antenna 221.

In some embodiments, the general processor 206, the memory 214, the baseband processor(s) 216, and the RF resources 218, 219 may be included in the multi-SIM wireless communication device 200 as a system-on-chip 250. In some embodiments, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the multi-SIM wireless communication device 200 may include, but are not limited to, a keypad 224, a touchscreen display 226, and the microphone 212.

Functioning together, the two SIMs 204a, 204b, the baseband processor BB1, BB2, the RF resources 218, 219, and the wireless antennas 220, 221 may support communications using two or more communication technologies or RATs. For example, the multi-SIM wireless communication device 200 may be configured to support two different RATs, such as LTE or WCDMA, and GSM. More RATs may be supported on the multi-SIM wireless communication device 200.

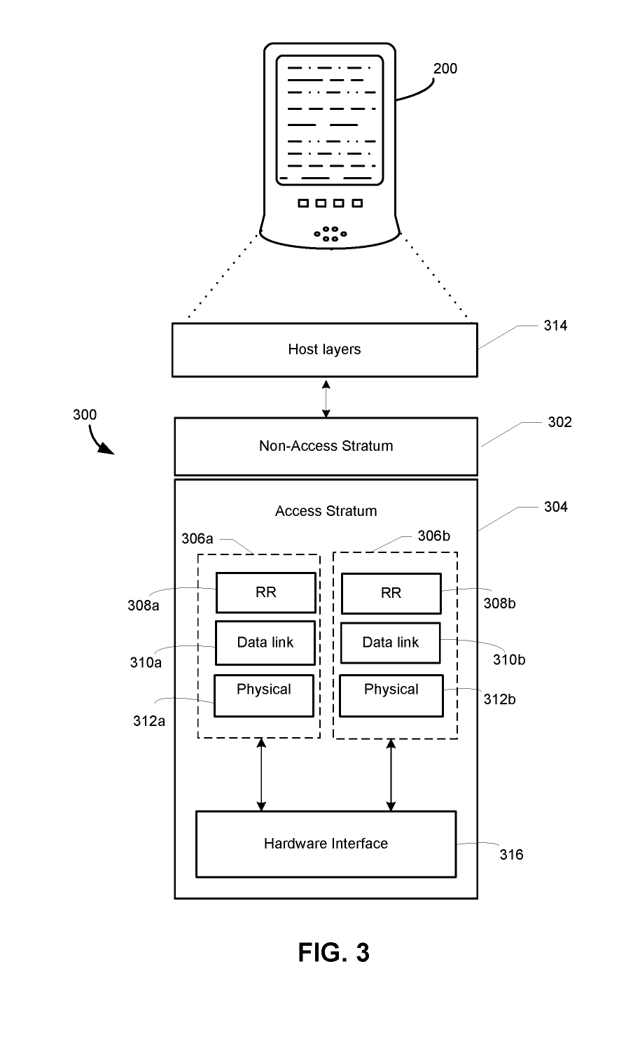

FIG. 3 illustrates an embodiment of a software architecture with layered radio protocol stacks that may be used in data communications on a wireless communication device. Referring to FIGS. 1-3, the wireless communication device 200 may have a layered software architecture 300 to communicate over access networks associated with one or more SIMs. The software architecture 300 may be distributed among one or more processors, such as the baseband-modem processor 216.

The software architecture 300 may include a Non Access Stratum (NAS) 302 and an Access Stratum (AS) 304. The NAS 302 may include functions and protocols to support traffic and signaling for the one or more SIMs on the wireless communication device 200 (e.g., the SIM-1 204a and/or the SIM-2 204b) and their respective core networks. The AS 304 may include functions and protocols that support communication between each SIM (e.g., the SIM-1 204a and/or the SIM-2 204b) and entities of their respective access networks (e.g., a mobile switching center (MSC) in a GSM network, eNodeB in an LTE network, etc.).

In the wireless communication device 200, the AS 304 may include multiple protocol stacks, each of which may be associated with a different SIM. For example, the AS 304 may include protocol stacks 306a, 306b, associated with a first SIM subscription and a second SIM subscription, respectively. Although described below with reference to GSM-type communication layers, protocol stacks 306a, 306b may support any of variety of standards and protocols for wireless communications. In particular, the AS 304 may include at least three layers, each of which may contain various sublayers. For example, each protocol stack 306a, 306b may respectively include a Radio Resource (RR) sublayer 308a, 308b as part of Layer 3 (L3) of the AS 304 in a GSM or LTE signaling protocol. The RR sublayers 308a, 308b may oversee the establishment of a link between the wireless communication device 200 and associated access networks.

In the various embodiments, the NAS 302 and RR sublayers 308a, 308b may perform the various functions to search for wireless networks and to establish, maintain, and terminate calls. Further, the RR sublayers 308a, 308b may provide functions including broadcasting system information, paging, and establishing and releasing a radio resource control (RRC) signaling connection between the wireless communication device 200 and the associated access network.

While not shown, the software architecture 300 may include additional Layer 3 sublayers, as well as various upper layers above Layer 3. Additional sub-layers may include, for example, connection management (CM) sub-layers (not shown) that route calls, select a service type, prioritize data, perform QoS functions, etc.

Residing below the Layer 3 sublayers (RR sublayers 308a, 308b), the protocol stacks 306a, 306b may also include data link layers 310a, 310b, which may be part of Layer 2 in a GSM or LTE signaling protocol. The data link layers 310a, 310b may provide functions to handle incoming and outgoing data across the network, such as dividing output data into data frames and analyzing incoming data to ensure the data has been successfully received.

In some embodiments, each data link layer 310a, 310b may contain various sublayers, such as a media access control (MAC) sublayer, a radio link control (RLC) sublayer, and a packet data convergence protocol (PDCP) sublayer, each of which form logical connections terminating at the access network. In various embodiments, a PDCP sublayer may provide uplink functions including multiplexing between different radio bearers and logical channels, sequence number addition, handover data handling, integrity protection, ciphering, and header compression. In the downlink, the PDCP sublayer may provide functions that include in-sequence delivery of data packets, duplicate data packet detection, integrity validation, deciphering, and header decompression.

In the uplink, the RLC sublayer may provide segmentation and concatenation of upper layer data packets, retransmission of lost data packets, and Automatic Repeat Request (ARQ). In the downlink, the RLC sublayer functions may include reordering of data packets to compensate for out-of-order reception, reassembly of upper layer data packets, and ARQ. In the uplink, the media access control (MAC) sublayer may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

Residing below the data link layers 310a, 310b, the protocol stacks 306a, 306b may also include physical layers 312a, 312b, which may establish connections over the air interface and manage network resources for the wireless communication device 200. In various embodiments, the physical layers 312a, 312b may oversee functions that enable transmission and/or reception over the air interface using two or more different communication technologies or RATs. Examples of such physical layer functions may include cyclic redundancy check (CRC) attachment, coding blocks, scrambling and descrambling, modulation and demodulation, signal measurements, MIMO, etc.

While the protocol stacks 306a, 306b provide functions to transmit data through physical media, the software architecture 300 may further include at least one host layer 314 to provide data transfer services to various applications in the wireless communication device 200. In other embodiments, application-specific functions provided by the at least one host layer 314 may provide an interface between the protocol stacks 306a, 306b and the general purpose processor 206. In some embodiments, the protocol stacks 306a, 306b may each include one or more higher logical layers (e.g., transport, session, presentation, application, etc.) that provide host layer functions. For example, in some embodiments, the software architecture 300 may include a network layer (e.g., Internet Protocol (IP) layer) in which a logical connection terminates at a gateway. In some embodiments, the software architecture 300 may include an application layer in which a logical connection terminates at another device (e.g., end user device, server, etc.). In some embodiments, the software architecture 300 may further include in the AS 304 a hardware interface 316 between the physical layers 312a, 312b and the communication hardware (e.g., one or more RF resource).

In various embodiments, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

As described, the modem stacks in various embodiments may support any of a variety of current and/or future protocols for wireless communications, referred to herein as communication technologies. For example, the modem stacks in various embodiments may support networks using radio access technologies described in 3GPP standards (e.g., GSM, UMTS, LTE, etc.), 3GPP2 standards (e.g., 1×RTT/CDMA2000, evolution data optimized (EV-DO), etc.) and/or Institute of Electrical and Electronics Engineers (IEEE) standards (WiMAX, Wi-Fi, etc.).

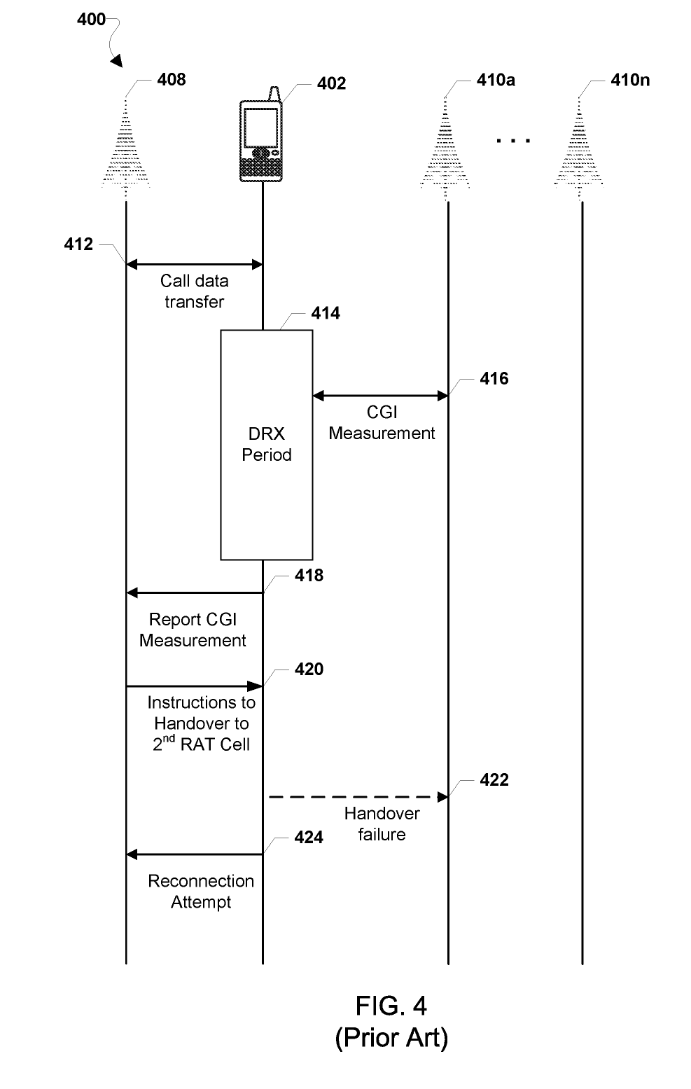

FIG. 4 includes a call flow diagram 400 illustrating CGI measurements and reporting by a wireless communication device 402 according to conventional methods. A subscription on the wireless communication device 402 may communicate with a first cell 408 of a wireless network using a first communication technology or RAT (e.g., LTE). The wireless network may also support communications with wireless communication devices using a second communication technology or RAT (e.g., GSM). The wireless network may implement the second communication technology in a number of cells 410a-410n. The cells 410a-410n may be, for example, femtocells that are low power base stations each serving small geographic areas.

In the example illustrated in FIG. 4, the wireless communication device 402 is supporting an active call (e.g., a voice or data call) with the wireless network using a first communication technology (e.g., LTE) with a cell 408 in communications 412. The wireless communication device 402 may be communicating with the wireless network cell 408 in DRX mode. In the DRX mode, the RF resource of the wireless communication device t 402 may receive a burst of call data in communications 412 followed by a pause in the call data during a DRX period 414. At the end of the DRX period 414, the RF resource of the wireless communication device 402 may wake up and receive another burst of call data before returning to its idle state in the next DRX period.

The wireless network may transmit an RRC reconfiguration message to the wireless communication device 402 including a list of frequencies of the cells 410a-410n supporting the second communication technology (e.g., GSM), which may be neighboring cells around the wireless communication device 402. The wireless network may also transmit a message instructing the wireless communication device 402 to obtain and report the CGI information of a cell supporting the second communication technology. For example, the RRC reconfiguration message may include a measConfig message specifying that the CGI of a cell supporting the GSM communication technology. Conventionally, the wireless communication device 402 selects the first cell in the list of cells received from the wireless network and performs a CGI measurement of the selected cell in operation 416. For example, the wireless communication device 402 may select the cell 410a and perform a CGI measurement of the cell 410a. To do so, the shared RF resource may be tuned from the first cell 408 to the frequency of the selected cell 410a during the DRX period 414 to perform the CGI measurement.

The wireless communication device 402 may decode the SIB/MIB obtained from the CGI measurement to obtain the CGI, PLMN, LAC, and other information of the cell 410a. The wireless communication device 402 may then report the CGI information to the wireless network in communication 418.

In some situations, the wireless network may instruct the wireless communication device 402 to perform a handover to a cell (e.g., 410a) in a communication 420. If the connection attempt 422 fails, the handover also fails. The wireless communication device 402 may enter an out of service state when the handover fails, so to reestablish the call the first subscription 424 may make a reconnection attempt with the first network 408 in communications 420. Even though other neighboring cells could provide better service using the second communication technology, the wireless communication device 402 is configured to connect with the first neighboring cell on the list of neighboring cells received from the network.

Various embodiments improve the likelihood that a CGI measurement will be successfully completed by evaluating the signal strength and/or handover history of all neighboring cells supporting the second communication technology (e.g., GSM) to pick a cell for CGI measurements rather than simply selecting the first neighboring cell on the list of neighboring cells provided by the wireless network. The neighboring cell with the strongest signal strength and/or most reliable handover history may be selected for performing the CGI measurement.

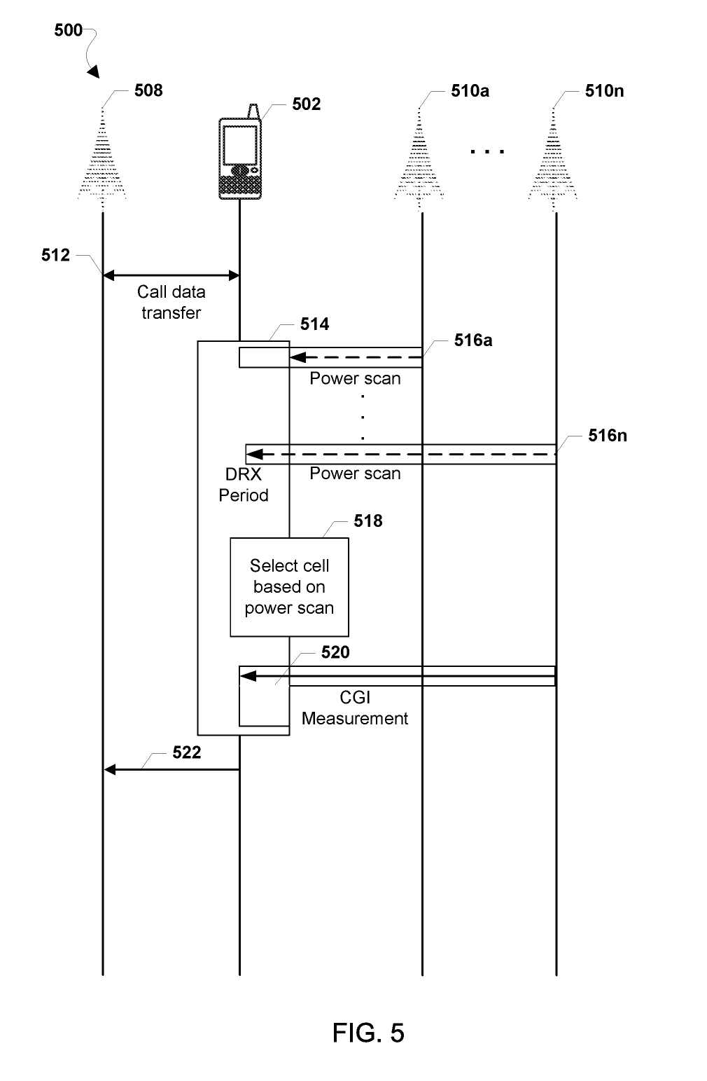

FIG. 5 is a call flow diagram 500 illustrating a measurements of CGI values of a cell by a wireless communication device 502 according to various embodiments. The wireless communication device 502 may communicate with a wireless network via a first cell 508 using a first communication technology or RAT (e.g., LTE). The wireless network may also support communications with wireless communication devices using a second communication technology or RAT (e.g., GSM). The wireless network may implement the second communication technology in a number of cells 510a-510n. The cells 510a-510n may be, for example, femtocells that are low power base stations each serving small geographic areas.

In the example illustrated in FIG. 5, the wireless communication device 502 is supporting an active call (e.g., a voice or data call) with the first cell 508 using a first communication technology (e.g., LTE) in communications 512. The wireless communication device 502 may be communicating with the first network in DRX mode. In the DRX mode, the wireless communication device 502 may receive a burst of call data in communications 512 followed by a pause in the call data during a DRX period 514. At the end of the DRX period 514, and RF resource of the wireless communication device 502 may wake up and receive another burst of call data before returning to an idle state in the next DRX period.

The wireless network may transmit an RRC reconfiguration message to the wireless communication device 502 including a list of frequencies of cells 510a-510n supporting a second communication technology a rat (e.g., GSM), which may be neighboring cells around the wireless communication device 502. The wireless network may also transmit a message instructing the wireless communication device 502 to obtain and report the CGI information of a cell supporting the second communication technology. For example, the wireless network may transmit an RRC reconfiguration message that includes a measConfig message element specifying that the CGI of a cell supporting the GSM communication technology should be obtained and reported to the network. During the DRX period 514, the wireless communication device 502 may conduct power scans of all of the cells 510a-510n supporting the second communication technology in operations 516a-516n. For example, the wireless communication device 502 may tune an RF resource to each of the frequencies in the RRC reconfiguration message and measure the signal strength at each frequency.

In operation 518, a processor of the wireless communication device 502 may select a neighboring cell based on the results of the power scan. In some embodiments, the processor of the wireless communication device 502 may select the neighboring cell with the highest signal strength. If there are several neighboring cells with similar signal strength, the processor of the wireless communication device 502 may select a neighboring cell with reliable handover history. The wireless communication device 502 may store a database with information about prior CGI measurements and/or communication technology handovers between the first communication technology (e.g., LTE) and the second communication technology (e.g., GSM). For example, the database may store the time and location of each prior CGI measurement and/or communication technology handover, the frequency and/or CGI of the neighboring cell that was used to perform the communication technology handover, a record of whether the CGI measurement and/or communication technology handover was successful, and additional relevant information. Given neighboring cells with similar signal strengths, a neighboring cell from which the wireless communication device 502 has reliably obtained CGI measurements in the past may be selected over neighboring cells with similar power measurements.

For example, in operation 518 the wireless communication device 502 may select the cell 510n based on the power scans in operations 516a-516n and/or the information of prior CGI measurements. The wireless communication device 502 may perform a CGI measurement, including receiving and decoding the SIB/MIB obtained from the CGI measurement to obtain the CGI, PLMN, LAC, and other information about the selected neighboring cell in operation 520. The CGI measurement of the selected cell 510n may be performed during the same DRX period as the power scans (i.e., the DRX period 514 as illustrated), or may be performed in a subsequent DRX period.

The wireless communication device 502 may report the CGI information regarding the selected cell 510n to the wireless network in communications 522. The wireless network may use the received CGI information for a number of uses, including in some cases directing the wireless communication device 502 to perform a communication technology handover to the selected cell 510n (not shown).

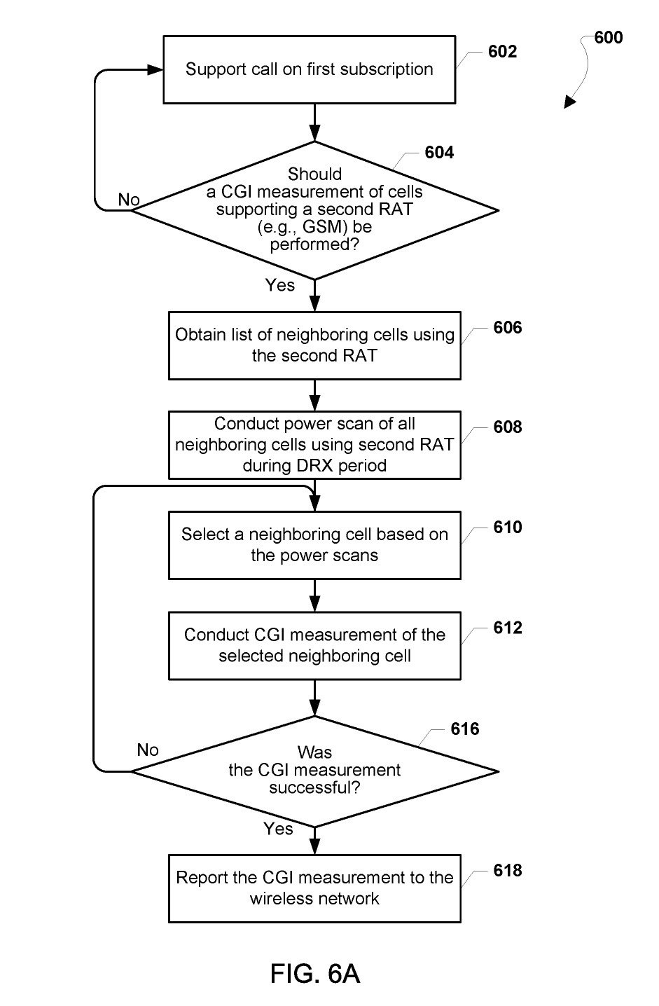

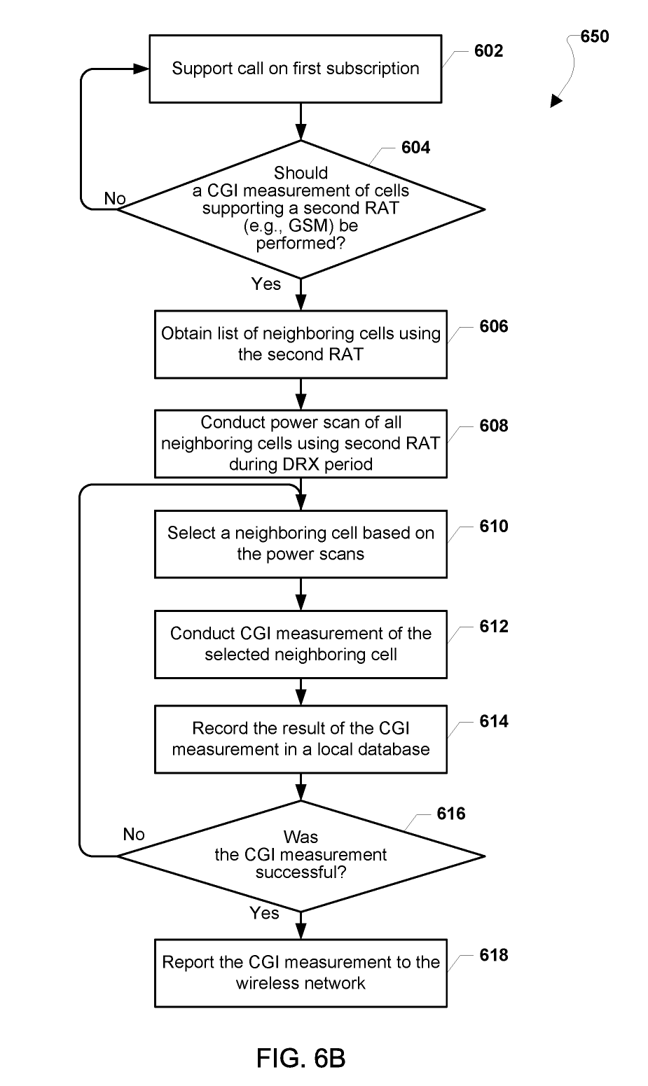

FIG. 6A illustrates a method 600 for performing CGI measurements of neighboring cells using a communication technology (e.g., GSM) different from the communication technology being used in an ongoing call on a wireless communication device according to various embodiments. With reference to FIGS. 1-6A, the method 600 may be implemented with a processor (e.g., the general processor 206, the baseband modem processor 216, a separate controller, and/or the like) of a wireless communication device (such as the wireless communication devices 110, 120, 200, 502). For example, the wireless communication device may be an MSMS wireless communication device or an MSMA wireless communication device having a first subscription and a second subscription.

In block 602, the wireless communication device may be supporting a call, such as a voice call or a data call, with a wireless network using a first communication technology (e.g., LTE). The wireless communication device may be conducting the call in DRX mode.

In determination block 604, the processor of the wireless communication device may determine whether a message is being received from the wireless network indicating that the CGI measurement of neighboring cells supporting a second communication technology or RAT (e.g., GSM) should be performed. For example, the processor may receive an RRC reconfiguration message including a measConfig message element indicating that a CGI measurement of a neighboring GSM cell should be obtained and reported to the wireless network. For example, if the wireless network determines that the wireless communication device is approaching a cell boundary for LTE service on cell currently supporting communications, and thus may lose LTE service, and the wireless network may request the CGI measurement is a first step towards causing the wireless communication device to perform a communication technology handover to a cell using the GSM communication technology. So long as the wireless communication device is not received a message from the wireless network to conduct a CGI measurement of a cell using a second communication technology (i.e., determination block 604=“No”), the wireless communication device may continue to support the call using the first communication technology in block 602.

In response to determining that a CGI measurement of the cells supporting the second communication technology should be performed (i.e., determination block 604=“Yes”), the processor may obtain a list of neighboring cells using the second communication technology (e.g., GSM) from the wireless network in block 606. The wireless network may periodically transmit an RRC reconfiguration message that includes a list of frequencies for neighboring cells supporting the second communication technology, and the processor may store the received list in memory. Thus, in block 606, the processor may recall the list of neighboring cells supporting the second communication technology from memory. In some instances, an RRC reconfiguration message indicating that a CGI measurement of a neighboring cell using the second communication technology (e.g., including a measConfig message element) may also include the list of frequencies of neighboring cells supporting the communication technology.

In block 608, the processor may conduct a power scan of all neighboring cells supporting the second communication technology (e.g., GSM). The power scans may be conducted during a DRX period of the current call using the first communication technology. The power scans may include tuning the RF resource to each neighbor cell frequency and measuring the signal strength at that frequency.

In block 610, the processor may select a neighboring cell for conducting the CGI measurements based on the results of the power scans. In some embodiments, the processor may select the neighboring cell with the highest signal strength. If there are several neighboring cells with similar signal strength, the processor may select a neighboring cell with a history. Given neighboring cells with similar signal strengths, a neighboring cell from which the wireless communication device has reliably completed CGI measurements in the past may be selected in block 610 over neighboring cells.

In block 612, the processor may conduct a CGI measurement of the selected neighboring cell. In this operation, the second subscription may receive and decode the SIB/MIB transmitted from the selected neighboring cell to obtain the CGI, as well as PLMN, LAC, and other information about the selected neighboring cell. The CGI measurement may be conducted during the same or different DRX period as the power scans performed in block 608.

In determination block 616, the processor may determine whether the CGI measurement was successfully completed. In this operation, the processor may determine whether the SIB and MIB were successfully decoded and that all information associated with CGI measurement was obtained.

In response to determining that the handover was successfully completed (i.e., determination block 616=“Yes”), the processor may I report the CGI measurements of the selected neighboring cell to the wireless network in block 618. For example, the wireless communication device may report the CGI measurement results to the wireless network using the communication link established with a cell using the first communication technology (e.g., LTE) and supporting the ongoing call.

In response to determining that the CGI measurement was not successfully completed (i.e., determination block 616=“No”), the processor may select another neighboring cell for performing the CGI measurement in block 610. For example, the processor may select the neighboring cell with the next highest signal strength and/or second most reliable according to the information of prior CGI measurement. In this manner, the method 600 provides a way to increase the likelihood of a successful CGI measurement of a self-supporting a second communication technology (e.g., GSM) by evaluating the strength and/or reliability of all neighboring cells before attempting the CGI measurement.

FIG. 6B illustrates a method 650 for performing CGI measurements of neighboring cells using a second communication technology (e.g., GSM) different and maintaining a database of such CGI measurements on a wireless communication device according to various embodiments. With reference to FIGS. 1-6B, the method 650 may be implemented with a processor (e.g., the general processor 206, the baseband modem processor 216, a separate controller, and/or the like) of a wireless communication device (such as the wireless communication devices 110, 120, 200, 502). The wireless communication device and processor may perform the operations of blocks 602-612 as described for the method 600.

After connecting the CGI measurement of the selected neighboring cell in block 612, the processor of the wireless communication device may record the results of the CGI measurement in a local database stored in memory in block 614. In some embodiments, the information stored in the local database in block 614 may include any information that relates to the reliability of obtaining a CGI measurement by the wireless communication device. Information stored in the local database may also include information regarding whether a subsequent communication technology handover was successfully completed. Thus, in some embodiments, the information stored in the local database in block 614 may include a record of whether the wireless communication device camped on the selected cell using the second communication technology (a “camping history”). Examples of information that may be stored in the local database include the time and location of each prior CGI measurement and/or communication technology handover, the frequency and/or CGI of the neighboring cell that was used to perform the communication technology handover, a record of whether the CGI measurement and/or communication technology handover was successful, and additional relevant information. The wireless communication device may then proceed with the operations in blocks 616 and 618 as described for the method 600. In this manner, the method 650 provides a way to increase the likelihood of a successful CGI measurement of a self-supporting a second communication technology (e.g., GSM) by evaluating the signal strength and/or reliability of all neighboring cells before attempting the CGI measurement.

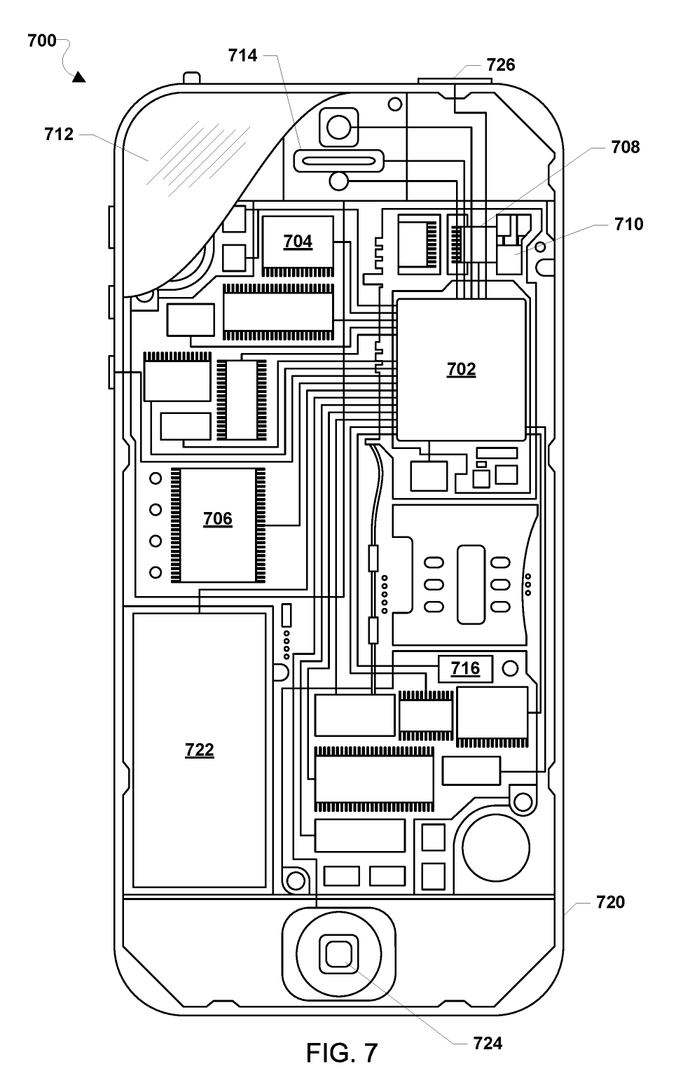

Various embodiments may be implemented in any of a variety of communication devices, an example of which (e.g., wireless communication device 700) is illustrated in FIG. 7. The wireless communication device 700 may be similar to the wireless communication devices 110, 120, 200, 502 as described. As such, the wireless communication device 700 may implement the methods 600 and 650 according to various embodiments.

The wireless communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the wireless communication device 700 need not have touch screen capability.

The wireless communication device 700 may have one or more cellular network transceivers 708 coupled to the processor 702 and to one or more antennas 710 and configured for sending and receiving cellular communications. The one or more transceivers 708 and the one or more antennas 710 may be used with the herein-mentioned circuitry to implement various embodiment methods. The wireless communication device 700 may include one or more SIM cards 716 coupled to the one or more transceivers 708 and/or the processor 702 and may be configured as described herein.

The wireless communication device 700 may also include speakers 714 for providing audio outputs. The wireless communication device 700 may also include a housing 720, constructed of a plastic, metal, or a combination of materials, for containing all or some of the components discussed herein. The wireless communication device 700 may include a power source 722 coupled to the processor 702, such as a disposable or rechargeable battery. The rechargeable battery may also be coupled to the peripheral device connection port to receive a charging current from a source external to the wireless communication device 700. The wireless communication device 700 may also include a physical button 724 for receiving user inputs. The wireless communication device 700 may also include a power button 726 for turning the multi-SIM wireless communication device 700 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one embodiment.

The foregoing method descriptions and the process flow diagrams are provided merely as illustrative embodiments and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more embodiment aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the written description. Thus, the present disclosure is not intended to be limited to the embodiments shown herein but is to be accorded the widest scope consistent with the following claims and the principles and novel features disclosed herein.

What is claimed is:

1. A method performed by a wireless communication device conducting a call with a wireless network using a first communication technology for performing a cell global identity (CGI) measurement of a cell supporting a second communication technology, comprising:
performing a power scan of each of a plurality of neighboring cells supporting the second communication technology;
selecting a neighboring cell from the plurality of neighboring cells based on the power scan of each of the plurality of neighboring cells;
conducting a CGI measurement of the selected neighboring cell; and
reporting results of the CGI measurement of the selected neighboring cell to the wireless network.

2. The method of claim 1, wherein performing the power scan for each of the plurality of neighboring cells supporting the second communication technology comprises performing the power scan for each of the plurality of neighboring cells supporting the second communication technology during a discontinuous reception period.

3. The method of claim 1, wherein selecting a neighboring cell from the plurality of neighboring cells comprises selecting a neighboring cell with a highest signal strength based on the power scan of each of the plurality of neighboring cells.

4. The method of claim 1, wherein selecting a neighboring cell from the plurality of neighboring cells comprising selecting a neighboring cell with a highest signal strength based on the power scan of each of the plurality of neighboring cells and on a prior camping history of cells using the second communication technology when two or more neighboring cells have similar power scan results.

5. The method of claim 1, further comprising:
determining whether the CGI measurement was successfully completed; and
in response to determining that the CGI measurement was not successfully completed:
selecting another neighboring cell from the plurality of neighboring cells based on the power scan of each of the plurality of neighboring cells;
conducting a CGI measurement of the selected other neighboring cell; and
reporting the CGI measurement of the selected other neighboring cell to the wireless network.

6. The method of claim 1, further comprising:
obtaining a list of the plurality of neighboring cells supporting the second communication technology from the wireless network, wherein the list comprises a radio resource control reconfiguration message including a frequency of each of the plurality of neighboring cells.

7. The method of claim 1, wherein the second communication technology is Global System for Mobile Communications (GSM).

8. The method of claim 7, wherein the first communication technology is Long Term Evolution (LTE).

9. A wireless communication device, comprising:
a radio frequency (RF) resource; and
a processor coupled to the RF resource and configured to support wireless communications with a wireless network using a first communication technology and using a second communication technology, wherein the processor is configured with processor-executable instructions to perform operations comprising:
performing a power scan of each of a plurality of neighboring cells supporting the second communication technology;
selecting a neighboring cell from the plurality of neighboring cells based on the power scan of each of the plurality of neighboring cells;
conducting a CGI measurement of the selected neighboring cell; and
reporting results of the CGI measurement of the selected neighboring cell to the wireless network.

10. The wireless communication device of claim 9, wherein the processor is configured with processor-executable instructions to perform operations such that performing the power scan for each of the plurality of neighboring cells supporting the second communication technology comprises performing the power scan for each of the plurality of neighboring cells supporting the second communication technology during a discontinuous reception period.

11. The wireless communication device of claim 9, wherein the processor is configured with processor-executable instructions to perform operations such that selecting a neighboring cell from the plurality of neighboring cells comprises selecting a neighboring cell with a highest signal strength based on the power scan of each of the plurality of neighboring cells.

12. The wireless communication device of claim 9, wherein the processor is configured with processor-executable instructions to perform operations such that selecting a neighboring cell from the plurality of neighboring cells comprising selecting a neighboring cell with a highest signal strength based on the power scan of each of the plurality of neighboring cells and on a prior camping history of cells using the second communication technology when two or more neighboring cells have similar power scan results.

13. The wireless communication device of claim 9, wherein the processor is configured with processor-executable instructions to perform operations further comprising:
determining whether the CGI measurement was successfully completed; and
in response to determining that the CGI measurement was not successfully completed:
selecting another neighboring cell from the plurality of neighboring cells based on the power scan of each of the plurality of neighboring cells;
conducting a CGI measurement of the selected other neighboring cell; and
reporting the CGI measurement of the selected other neighboring cell to the wireless network.

14. The wireless communication device of claim 9, wherein the processor is configured with processor-executable instructions to perform operations further comprising:
obtaining a list of the plurality of neighboring cells supporting the second communication technology from the wireless network, wherein the list comprises a radio resource control reconfiguration message including a frequency of each of the plurality of neighboring cells.

15. The wireless communication device of claim 9, wherein the second communication technology is Global System for Mobile Communications (GSM).

16. The wireless communication device of claim 15, wherein the first communication technology is Long Term Evolution (LTE).

17. A wireless communication device, comprising:
means for conducting a call with a wireless network using a first communication technology;
means for performing a power scan of each of a plurality of neighboring cells supporting a second communication technology;
means for selecting a neighboring cell from the plurality of neighboring cells based on the power scan of each of the plurality of neighboring cells;
means for conducting a CGI measurement of the selected neighboring cell; and
means for reporting results of the CGI measurement of the selected neighboring cell to the wireless network.

18. The wireless communication device of claim 17, wherein means for performing the power scan for each of the plurality of neighboring cells supporting the second communication technology comprises means for performing the power scan for each of the plurality of neighboring cells supporting the second communication technology during a discontinuous reception period.

19. The wireless communication device of claim 17, wherein means for selecting a neighboring cell from the plurality of neighboring cells comprises means for selecting a neighboring cell with a highest signal strength based on the power scan of each of the plurality of neighboring cells.

20. The wireless communication device of claim 17, wherein means for selecting a neighboring cell from the plurality of neighboring cells comprises means for selecting a neighboring cell with a highest signal strength based on the power scan of each of the plurality of neighboring cells and on a prior camping history of cells using the second communication technology when two or more neighboring cells have similar power scan results.

21. The wireless communication device of claim 17, further comprising:
means for determining whether the CGI measurement was successfully completed;
means for selecting another neighboring cell from the plurality of neighboring cells based on the power scan of each of the plurality of neighboring cells in response to determining that the CGI measurement was not successfully completed;
means for conducting a CGI measurement of the selected other neighboring cell; and
means for reporting the CGI measurement of the selected other neighboring cell to the wireless network.

22. The wireless communication device of claim 17, further comprising:
means for obtaining a list of the plurality of neighboring cells supporting the second communication technology from the wireless network, wherein the list comprises a radio resource control reconfiguration message including a frequency of each of the plurality of neighboring cells.

23. The wireless communication device of claim 17, wherein the second communication technology is Global System for Mobile Communications (GSM) and the first communication technology is not GSM.

24. A non-transitory processor-readable medium on which is stored processor-executable instructions configured to cause a processor of a wireless communication device to perform operations comprising:
conducting a call with a wireless network using a first communication technology;
performing a power scan of each of a plurality of neighboring cells supporting a second communication technology;
selecting a neighboring cell from the plurality of neighboring cells based on the power scan of each of the plurality of neighboring cells;
conducting a CGI measurement of the selected neighboring cell; and
reporting results of the CGI measurement of the selected neighboring cell to the wireless network.

25. The non-transitory processor-readable medium of claim 24, wherein the stored processor-executable instructions are configured to cause the processor to perform operations such that performing the power scan for each of the plurality of neighboring cells supporting the second communication technology comprises performing the power scan for each of the plurality of neighboring cells supporting the second communication technology during a discontinuous reception period.

26. The non-transitory processor-readable medium of claim 24, wherein the stored processor-executable instructions are configured to cause the processor to perform operations such that selecting a neighboring cell from the plurality of neighboring cells comprises selecting a neighboring cell with a highest signal strength based on the power scan of each of the plurality of neighboring cells.

27. The non-transitory processor-readable medium of claim 24, wherein the stored processor-executable instructions are configured to cause the processor to perform operations that selecting a neighboring cell from the plurality of neighboring cells comprising selecting a neighboring cell with a highest signal strength based on the power scan of each of the plurality of neighboring cells and on a prior camping history of cells using the second communication technology when two or more neighboring cells have similar power scan results.

28. The non-transitory processor-readable medium of claim 24, wherein the stored processor-executable instructions are configured to cause the processor to perform operations further comprising:
determining whether the CGI measurement was successfully completed; and
in response to determining that the CGI measurement was not successfully completed:
selecting another neighboring cell from the plurality of neighboring cells based on the power scan of each of the plurality of neighboring cells;
conducting a CGI measurement of the selected other neighboring cell; and
reporting the CGI measurement of the selected other neighboring cell to the wireless network.

29. The non-transitory processor-readable medium of claim 24, wherein the stored processor-executable instructions are configured to cause the processor to perform operations further comprising:
obtaining a list of the plurality of neighboring cells supporting the second communication technology from the wireless network, wherein the list comprises a radio resource control reconfiguration message including a frequency of each of the plurality of neighboring cells.

30. The non-transitory processor-readable medium of claim 24, wherein the second communication technology is Global System for Mobile Communications (GSM) and the first communication technology is not GSM.
